(19) United States
(12) Patent Application Publication
(10) Pub. No.: US 2018/0310108 A1
(43) Pub. Date: Oct. 25, 2018

(54) DETECTION OF MICROPHONE PLACEMENT

(71) Applicant: Vocollect, Inc., Pittsburgh, PA (US)

(72) Inventors: Richard Sharbaugh, New Kensington, PA (US); Ryan A. Zoschg, Pittsburgh, PA (US); Keith P. Braho, Murrysville, PA (US)

(21) Appl. No.: 15/493,451

(22) Filed: Apr. 21, 2017

(51) Int. Cl. H04R 29/00; H04R 1/10

(52) U.S. Cl. CPC H04R 29/004; H04R 2201/107; H04R 1/1008; H04R 1/1091

(57) ABSTRACT

A system directs boom microphone placement. A microphone is configured to capture speech audio from a user and output corresponding electrical signals. A proximity sensor is situated adjacent the microphone and configured to produce output signals representative of a distance from the microphone to the user's face or mouth. A headset assembly includes a boom carrying the microphone and the proximity sensor, where the boom can be adjusted to a plurality of positions adjacent the user's face or mouth. Processing circuitry is coupled to receive the output signals from the proximity sensor and produce an output indicative that the microphone is outside a prescribed distance or range of distances from the user's face or mouth.

### FIELD OF THE INVENTION

Certain embodiments of the invention relate to speech-based systems, and in particular, to systems for speech-directed or speech-assisted work environments that utilize speech recognition.

### BACKGROUND

Speech recognition has simplified many tasks in the workplace by permitting hands-free communication with a computer as a convenient alternative to communication via conventional peripheral input/output devices. A user may enter data and commands by voice using a device having processing circuitry with speech recognition features. Commands, instructions, or other information may also be communicated to the user by speech synthesis circuitry of the processing circuitry. Generally, the synthesized speech is provided by a text-to-speech (TTS) engine in the processing circuitry. Speech recognition finds particular application in mobile computing environments in which interaction with the computer by conventional peripheral input/output devices is restrictive or otherwise inconvenient.

As the users process their orders and complete their assigned tasks, a bi-directional dialog or communication stream of information is provided over a wireless network between the users wearing mobile wireless devices and the central computer system that is directing multiple users and verifying completion of their tasks. To direct the user's actions, information received by each mobile device from the central computer system is translated into speech or voice instructions for the corresponding user. To receive the voice instructions, the user can wear a headset coupled with the mobile device.

The headset includes one or more microphones for spoken data entry, and one or more speakers for playing audio. Speech from the user is captured by the headset and is converted using speech recognition functionalities into data used by the central computer system. Similarly, instructions from the central computer or mobile device are delivered to the user as speech via the TTS engine's generation of speech and audio and the headset speaker. Using such mobile devices, users may perform assigned tasks virtually hands-free so that the tasks are performed more accurately and efficiently.

However, a system's ability to accurately recognize and process the user's speech is dependent on the quality of the speech audio that is captured from the user. If the microphone is not positioned properly with respect to the user's mouth, for example, the ratio of user speech versus background noise (signal to noise ratio SNR) decreases. As a result, the speech recognition system may not receive a quality speech input, and may misinterpret the user's spoken audio. This degrades the speech recognition process and increases processing error rates. It also may require repetition of previously spoken dialog, instructions, or commands. Some users particularly have problems because they may not know what the best microphone position is, or do not want the microphone in front of their face, and choose to orient the microphone in a position that does not facilitate accurate capture of the user's voice. For example, moving the microphone so that it is adjacent to the user's forehead or below their chin or otherwise out of the way, often produces unacceptable voice quality and a poor signal to noise ratio (SNR).

Therefore, there is a need to ensure suitable speech quality and subsequent speech recognition.

### SUMMARY

Accordingly, in one aspect, a system for directing boom microphone placement has a microphone configured to capture audio from a user and output corresponding electrical signals. A proximity sensor is situated adjacent the microphone and configured to produce output signals indicative of a distance from the microphone to the user's face or mouth. A headset assembly, including an adjustable boom carrying the microphone and the proximity sensor, can be adjusted to a plurality of positions adjacent the user's face or mouth. Processing circuitry is coupled to receive the output signals from the proximity sensor and produce an output indicative of the microphone's placement with respect to the user's face or mouth.

In certain example embodiments, the system also has a speaker configured to play audio to the user, and where the output provided to the user comprises an audio prompt played through the speaker. In certain example embodiments, the audio prompt advises the user to move the microphone closer to or further away from the face or mouth of the user. In certain example embodiments, the audio prompt includes one or more tones associated with placement of the microphone. In certain example embodiments, the output provided to the user is in the form of a visual indicator. In certain example embodiments, the visual indicator comprises one or more lights. In certain example embodiments, the system includes a portable computer terminal, where the processing circuitry is contained in the portable computer terminal. In certain example embodiments, the processing circuitry is situated within the headset assembly. In certain example embodiments, the processing circuitry compares output signals from the proximity sensor to threshold voltages to determine if the microphone is situated within the prescribed range of distances from the user' face or mouth. In certain example embodiments, the processing circuitry is further configured to perform speech recognition on the electrical signals from the microphone that are associated with the captured audio. In certain example embodiments, the prescribed range of distances from the user's face or mouth is between approximately ¼ inch and approximately 1 inch.

In another example embodiment, a method for enhancing boom microphone placement involves: providing headset having a boom; the boom carrying a microphone and configured to capture audio from a user and output corresponding electrical signals; the boom further carrying a proximity sensor situated adjacent the microphone and configured to produce output signals representative of a distance from the microphone to the user's face or mouth; where the boom can be adjusted to a plurality of positions adjacent the user's face or mouth; at a processing circuit, receiving output signals from the proximity sensor; and at the processing circuit, producing a feedback signal to the user indicative of a position of the microphone with respect to the user's face or mouth.

In certain example embodiments, the feedback signal provided to the user comprises an audio prompt played through a speaker forming part of the headset. In certain example embodiments, the audio prompt advises the user to move the microphone closer to or further away from the face or mouth of the user. In certain example embodiments, the audio prompt comprises one or more tones associated with placement of the microphone. In certain example embodiments, the feedback signal provided to the user is in the form of a visual indicator. In certain example embodiments, the visual indicator comprises one or more lights.

In another example system for directing boom microphone placement, the system has a microphone configured to capture speech audio from a user and output corresponding electrical signals. A proximity sensor is situated adjacent the microphone and configured to produce output signals representative of a distance from the proximity sensor to the user's face or mouth. A headset assembly has an adjustable boom carrying the microphone and the proximity sensor, where the boom can be adjusted to a plurality of positions adjacent the user's face or mouth. A portable computer terminal is provided with processing circuitry residing within the portable computer terminal that is coupled to receive the output signals from the proximity sensor and produce an output indicative that the microphone is outside a prescribed distance or range of distances from the user's face or mouth. A speaker is configured to play a feedback audio signal to the user, and the feedback audio signal provided to the user includes an audio prompt played through the speaker, where the audio prompt advises the user to move the microphone closer to or further away from the face or mouth of the user.

In certain example embodiments, the processing circuitry compares output signals from the proximity sensor to threshold voltages to determine if the microphone is situated within the prescribed range of distances from the user' face or mouth. In certain example embodiments, the processing circuitry is further configured to perform speech recognition on the electrical signals from the microphone that are associated with the captured speech audio.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 is a perspective view of a user operating a system which incorporates the present invention.

FIG. 2 is an enlarged perspective view of the headset of FIG. 1 which incorporates a proximity sensor component consistent with certain example embodiments of the present invention.

FIG. 3 is a block diagram of an embodiment of an example system consistent with the present invention.

FIG. 4 is a flowchart representation of an example of an operational process consistent with certain embodiments of the present invention.

FIG. 5 is a diagram of an example simplified circuit that processes signals from the proximity sensor.

It should be understood that the appended drawings are not necessarily to scale, presenting a somewhat simplified representation of various features illustrative of the basic principles of embodiments of the invention. The specific design features of embodiments of the invention as disclosed herein, including, for example, specific dimensions, orientations, locations, and shapes of various illustrated components, as well as specific sequences of operations (e.g., including concurrent and/or sequential operations), will be determined in part by the particular intended application and use environment. Certain features of the illustrated embodiments may have been enlarged or distorted relative to others to facilitate visualization and provide a clear understanding.

### DETAILED DESCRIPTION

In the following detailed description of the invention, numerous specific details are set forth in order to provide a thorough understanding of the invention. However, it is to be understood that the invention may be practiced without these specific details. In other instances, well known methods, procedures, components, and circuits have not been described in detail so as not to unnecessarily obscure aspects of the invention.

Embodiments of the present invention are directed to a system for improving speech recognition accuracy, by monitoring the position of a user's headset-mounted microphone, and prompting the user to move or reposition the microphone if required.

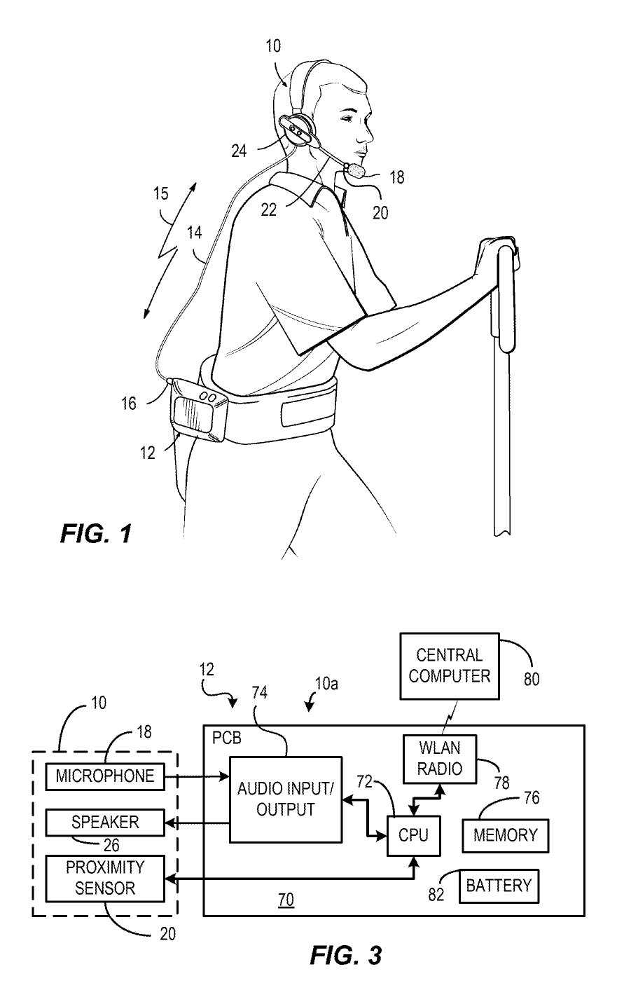

FIG. 1 depicts an example system implementing an embodiment of the invention, including a user-worn headset assembly 10 coupled to a portable computer terminal or other device 12 by a communication cable 14 or wireless link 15. The communication cable 14 may interface with the portable computer terminal 12 by utilizing a suitable plug 16 and mating receptacle (not shown). In an alternate embodiment, the headset assembly 10 may communicate wirelessly with the portable computer terminal 12 using available wireless technology, such as Bluetooth™ technology.

The headset assembly 10 includes a microphone 18, such as a boom microphone, and a proximity sensor 20. The proximity sensor 20 is situated near the end of the boom adjacent the microphone 18 so as to measure a distance that is indicative of the distance from the microphone 18 to the user's face or mouth.

The microphone 18 is attached to a boom 22 and may be positioned in a plurality of positions. A proximity sensor 20 is also connected to the boom 22. In the illustrated embodiment, the boom 22 coupled to microphone 18 may be coupled to a rotatable earpiece assembly 24. The user may also position the microphone 18 by bending or otherwise contorting a flexible microphone boom 22, which can be made of a flexible, yet shape retaining, material.

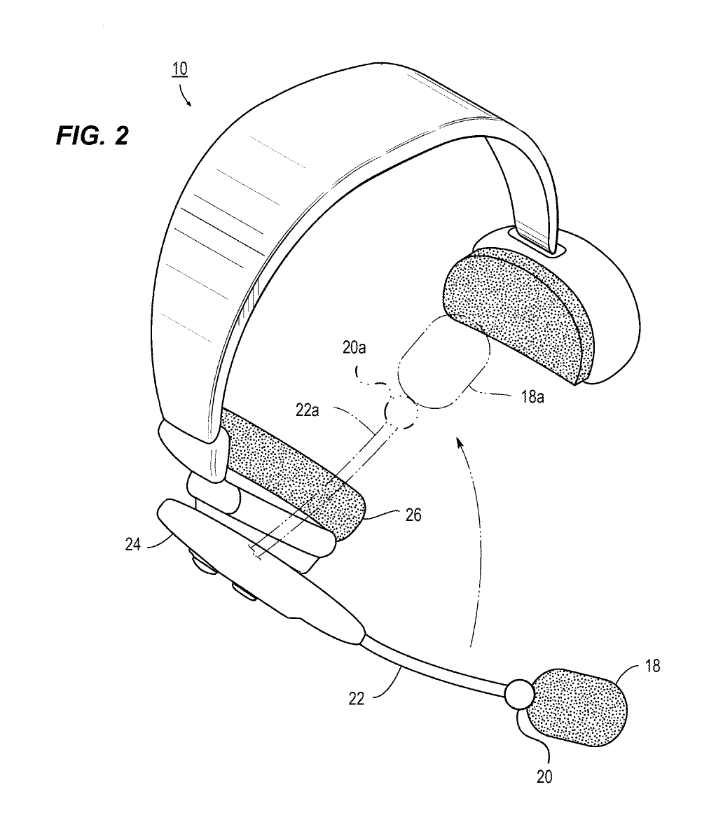

FIG. 2 is an enlarged view of the headset assembly 10. An earpiece speaker 26 is located approximately coaxially with the earpiece assembly 24. The speaker may be used to provide audio prompts or commands or feedback to the user. The microphone 18 and microphone boom 22 may be positioned in front of the user's face or mouth, as shown at 18 and 22. Alternatively, the microphone 18, proximity sensor 20, and microphone boom 22 can be located at points more distant from the user's face or mouth, to include positions at 18a, 20a, and 22a for example.

A device, such as the portable computer terminal 12 or headset assembly 10, can be configured to be operable to monitor a specific parameter associated with the headset and/or the microphones, and provide an audible or visual prompt to the user to make an adjustment with respect to the headset assembly. In one example embodiment consistent with the invention, the device monitors proximity of the microphone and boom assembly to a user's face as an indicator of the correct position of the microphone. The proximity sensor and associated processing circuitry produces an output indicative of the suitability of the microphone's position for speech recognition (or other communication) purposes.

While the illustrated embodiment shows a separate headset assembly 10 and terminal 12, the processing circuitry and functionality of the separate devices could be combined in a headset such that the headset incorporates its traditional functions, along with the functions of the computer terminal device 12.

Thus, the system, in accordance with one embodiment of the present invention includes a microphone 18 that is configured to capture speech audio from the user and output corresponding electrical signals. The proximity sensor 20 is situated adjacent the microphone and is configured to produce output signals representative of a distance from the proximity sensor to the user's face or mouth. Desirably, the microphone is very close to the face or mouth but outside of the direct path that would produce wind noise sounds from the air leaving the user's mouth while speaking (or just breathing) and passing over the microphone. The headset assembly has a flexible boom 22 that carries the microphone 18 and the proximity sensor 20. This boom can be adjusted to a number of positions adjacent the user's face or mouth so as to be adaptable to a variety of users. Processing circuitry receives the output signals from the proximity sensor 20 and produces an output indicative of a distance between the microphone 18 and the user's face or mouth. The processing circuitry is also configured to provide a feedback signal to the user if the microphone 18 is outside a prescribed distance or range of distances from the user's face or mouth. The headset also includes one or two speakers configured to play the audio to the user.

In most instances it has been found desirable that the microphone be situated between approximately ¼ inch and one inch from the user's face or mouth. Hence, the system is configured to look for output signals from the proximity sensor corresponding to this range of distances between microphone and user's face or mouth. When the proximity sensor indicates that the microphone is within this range, the system can proceed with normal tasks including two way communication with the user to provide instructions to the user and take information provided by the user.

In many instances, a system such as described herein is used to recognize a limited vocabulary of words that are spoken by the user, and the user trains the system to recognize his or her speech patterns by speaking some or all of the words in the vocabulary during a training process. The training process can also be carried out while the proximity sensor is operating and continues as long as the user's boom and microphone are properly adjusted.

Whenever the proximity sensor 20 produces an output indicative that the boom and microphone are not properly adjusted, the operational work process or training process may optionally be interrupted and the user is alerted that the boom needs to be adjusted. This can be an audible alert in the form of speech instructions provided through the headset speaker(s), an alert tone indicative of the need for adjustment, or a visual alert such as use of one or more lights such as LEDs on the boom within the user's field of vision. Alternatively, the visual alert can be provided by a display that either forms a part of the headset or which is remote to the headset. The feedback indicating need for adjustment of the boom may be general and merely advise the user of the need for adjustment, or the feedback can provide more specific information such as an indication that the microphone is too close or too far away. In certain example embodiments, the work or training process can be paused to allow for adjustment of the boom, or may continue without pause according to the particular embodiment.

Certain generic proximity sensors may not provide a consistent signal that would indicate an accurate measure of distance from microphone boom to face. Such sensors measure the intensity of reflected light which is a function of reflectivity and distance of the surface which the light is reflecting off. Things like skin tone or sheen could affect the magnitude of the reflected light as much or more than distance. However, such sensors may be used if a part of the training process normalizes the output from such a sensor for a particular user under a particular set of circumstances.

Other sensors measure distance accurately and consistently by determining how long it takes for transmitted light to return to the source. Measuring distance using the time of flight from transmit to reflection to receive is independent of the magnitude of reflected light as long as any light is reflected.

The present system incorporates suitable processing circuitry for processing the electrical signals associated with input audio captured by the microphone 18 and the proximity sensor 20. In accordance with one aspect of the invention, the processing circuitry might be implemented within the portable computer terminal 12. For example, such a portable terminal device might be a TALKMAN® device available from Honeywell Corporation of Pittsburgh, Pa. In an alternative embodiment of the invention, the processing circuitry might be implemented directly into the headset assembly 10. Therefore, the invention is not limited with respect to where the processing circuitry is located, as long as it is suitably coupled for monitoring the proximity sensor output.

FIG. 3 illustrates one example of suitable processing circuitry that might be implemented for the purposes of the invention. Specifically, the processing circuitry 70 may include one or more suitable processors or CPU's 72. An audio input/output stage 74 is appropriately coupled to a headset assembly 10 for coupling the processing circuitry 70 with the microphone 18 and speaker 26. Processor 72 may be provided with one or more memory elements 76, as appropriate for implementation of the invention. Generally, memory element 76 contains data and applications that are executed by the processor 72 for implementing the invention and carrying out other functions.

The processing circuitry might also incorporate a suitable radio, such as a wireless local area network (WLAN) radio, for coupling to a central computer or server 80, as is appropriate in various speech-directed/speech-assisted work environments. To that end, the processing circuitry 70 and processor 72 might also run one or more speech recognition applications and text-to-speech (TTS) applications, as appropriate for such speech-directed or speech-assisted work environments. The processing circuitry 70 is powered by an appropriate power source, such as battery 82. As noted, the processing circuitry might be implemented in terminal 12, or might be included in the actual headset assembly as evidenced by reference numeral 10a in FIG. 3, or even in remote central computer 80.

In accordance with one aspect of the invention, the processing circuitry is coupled to receive the electrical signals from microphone 18 that correspond to or are associated with the captured speech audio, such as user speech. The processing circuitry 70 is also configured to process the output signals from the proximity sensor 20 to determine if the microphone 18 is properly positioned or in a desirable position with respect to a user's face and mouth. In one embodiment, processing circuitry 70 provides suitable commands, prompts, or other information to a user, such as through speaker 26, when the proximity sensor indicates that the microphone should be adjusted to instruct a user to move or reposition the microphone 18 as appropriate to improve the quality of the speech that is received from a user, for the purposes of improved speech recognition.

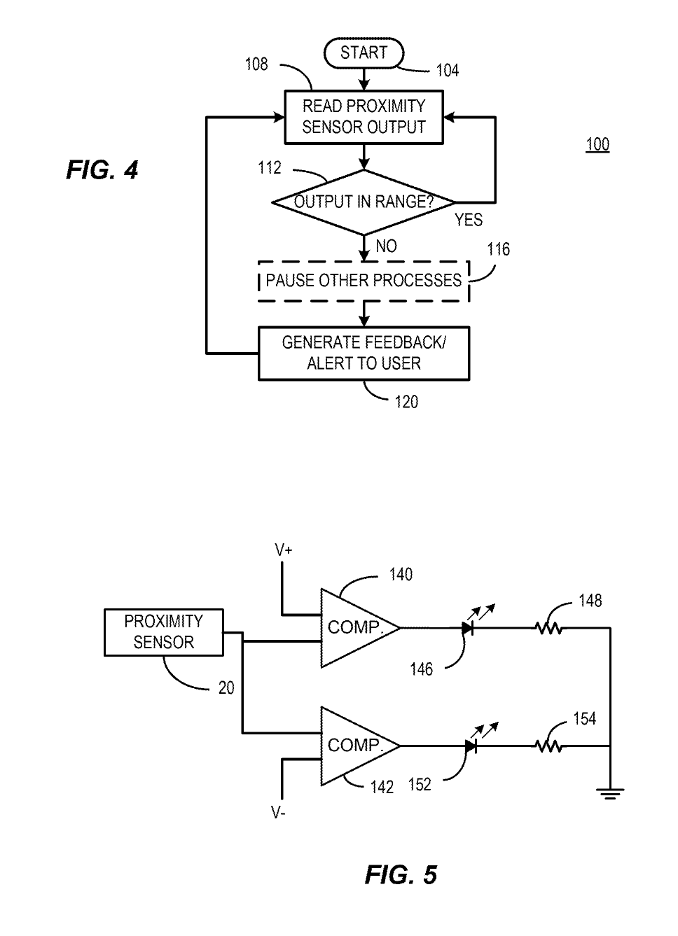

FIG. 4 is a flowchart of an example process 100 for operation of one example embodiment consistent with the invention. The process starts at 104 and the output signal from proximity sensor 20 is read at 108. If, at 112, the (possibly filtered) output from the proximity sensor is in a suitable range of values that represent a distance for optimal microphone placement (e.g., between ¼ and 1 inch) then no action is required with regards to microphone placement and the process returns to 108, possibly after a wait time (not shown).

If the output is not within the prescribed range at 112, then the system may optionally pause any processes such as speech-directed/speech-assisted work related processes at 116 and then generate a feedback signal for the user. This feedback signal is used to tell the user that the microphone boom should be adjusted to assure optimal speech processing. This feedback can be in the form of audible or visual signals to alert the user to adjust the boom.

In one example, the user can be provided with a synthesized speech command that indicates that the microphone is too close, too far away or simply should be adjusted. In other examples, the user can be provided with a visual indication that the microphone 18 is too close, too far away or simply should be adjusted. For example, two light emitting diodes (LEDs) (or a single multi-color LED) can be provided on the boom within the user's visual field with one color indicating the microphone 18 is too close and the other indicating the microphone 18 is too far away. In another example, a single color LED can indicate that the microphone is either properly or improperly situated. In another example, a visual display such as a display on the portable computer terminal 12 or another device such as a smart phone may be used to visually guide the user to properly adjust the microphone. Many variations will occur to those skilled in the art upon consideration of the present teachings.

Referring now to FIG. 5, another example embodiment is depicted in which simplified circuitry is utilized to detect that the microphone 18 is properly situated. In this example, the output of proximity sensor is a voltage level or is converted to a voltage level that can be compared with two reference voltages V+ and V− by comparators 140 and 142 respectively. Comparator 140 compares the output signal from proximity sensor 20 with a voltage level V+, which may represent a voltage for a minimum desirable distance as read by the proximity sensor 20 (note that this assumes that the minimum distance will produce a higher output from sensor 20 than that which will be produced at the maximum distance). Similarly, comparator 142 compares the output signal from proximity sensor 20 with a voltage level V−, which may represent a voltage for a maximum desirable distance as read by the proximity sensor 20. When the comparator 140 determines that the output signal is greater than V+, LED 146 is turned on through current limiting resistor 148. When the comparator 142 determines that the output signal is less than V−, LED 152 is turned on through current limiting resistor 154. In either case, the lighting of the LED is indicative that the microphone is either too close or too far away.

In other example embodiments, the comparators may be used to drive a single LED indicative that the boom should be adjusted whenever the output from the proximity sensor is either greater than V+ or less than V−. In another example, the output of the comparators may be used as logic signals that are fed to a processor, and rather than using visual alerts, an audible alert, such as in the form of synthesized speech or tones, can be used without limitation. In other embodiments, a gradient scale of feedback can be provided. In other words, the feedback could vary depending on how close the microphone is to the optimal position or range. For example, a slow beep or blink can be indicative that the microphone is far away, and a fast blink can be indicative that the microphone is very close, while a solid light or no beep is provided when the microphone is in a good position. Many other variations will occur to those skilled in the art upon consideration of the present teachings.

In yet another example, the processing circuitry may be configured to only look for distances as indicated by the proximity sensor that are too great (e.g., greater than about 1 inch). This can be accomplished using a CPU or using a single comparator. Many variations will occur to those skilled in the art upon consideration of the present teachings.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of representative apparatus and method, and illustrative examples shown and described. Accordingly, departures may be made from such details without departure from the spirit or scope of applicant's general inventive concept.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, several embodiments of the invention have been disclosed. The present invention is not limited to such example embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

What is claimed is:

1. A system for directing boom microphone placement, the system comprising:
a microphone configured to capture audio from a user and output corresponding electrical signals;
a proximity sensor situated adjacent the microphone and configured to produce output signals indicative of a distance from the microphone to the user's face or mouth;
a headset assembly, comprising an adjustable boom carrying the microphone and the proximity sensor, where the boom can be adjusted to a plurality of positions adjacent the user's face or mouth; and
processing circuitry coupled to receive the output signals from the proximity sensor and produce an output indicative of the microphone's placement with respect to the user's face or mouth.

2. The system according to claim 1, further comprising a speaker configured to play audio to the user, and where an output provided to the user comprises an audio prompt played through the speaker.

3. The system according to claim 2, where the audio prompt advises the user to move the microphone closer to or further away from the face or mouth of the user.

4. The system according to claim 2, where the audio prompt comprises one or more tones associated with placement of the microphone.

5. The system according to claim 1, where the output provided to the user is in the form of a visual indicator.

6. The system according to claim 5, where the visual indicator comprises one or more lights.

7. The system according to claim 1, further comprising a portable computer terminal, where the processing circuitry is contained in the portable computer terminal.

8. The system according to claim 1, where the processing circuitry is situated within the headset assembly.

9. The system according to claim 1, where the processing circuitry compares output signals from the proximity sensor to thresholds to determine if the microphone is situated within the prescribed range of distances from the user' face or mouth.

10. The system according to claim 1, where the processing circuitry is further configured to perform speech recognition on the electrical signals from the microphone that are associated with the captured audio.

11. The system according to claim 1, where the prescribed range of distances from the user's face or mouth is between approximately ¼ inch and approximately 1 inch.

12. A method for enhancing boom microphone placement, the method comprising:
providing a headset having a boom carrying a microphone configured to capture audio from a user and output corresponding electrical signals and a proximity sensor situated adjacent the microphone and configured to produce output signals representative of a distance from the microphone to the user's face or mouth, where the boom can be adjusted to a plurality of positions adjacent the user's face or mouth;
at a processing circuit, receiving output signals from the proximity sensor; and
at the processing circuit, producing a feedback signal to the user indicative of a position of the microphone with respect to the user's face or mouth.

13. The method according to claim 12, where the feedback signal provided to the user comprises an audio prompt played through a speaker forming part of the headset.

14. The method according to claim 13, where the audio prompt advises the user to move the microphone closer to or further away from the face or mouth of the user.

15. The method according to claim 13, where the audio prompt comprises one or more tones associated with placement of the microphone.

16. The method according to claim 12, where the feedback signal provided to the user is in the form of a visual indicator.

17. The method according to claim 16, where the visual indicator comprises one or more lights.

18. A system for directing boom microphone placement, the system comprising:
a microphone configured to capture speech audio from a user and to output corresponding electrical signals;
a proximity sensor situated adjacent the microphone and configured to produce output signals representative of a distance from the proximity sensor to the user's face or mouth;
a headset assembly, comprising an adjustable boom carrying the microphone and the proximity sensor, where the boom can be adjusted to a plurality of positions adjacent the user's face or mouth;
a portable computer terminal;
processing circuitry residing within the portable computer terminal and coupled to receive the output signals from the proximity sensor and produce an output indicative that the microphone is outside a prescribed distance or range of distances from the user's face or mouth; and
a speaker configured to play a feedback audio signal to the user, and where the feedback audio signal provided to the user comprises an audio prompt played through the speaker, where the audio prompt advises the user to move the microphone closer to or further away from the face or mouth of the user.

19. The system according to claim 18, where the processing circuitry compares output signals from the proximity sensor to threshold voltages to determine if the microphone is situated within the prescribed range of distances from the user' face or mouth.

20. The system according to claim 18, where the processing circuitry is further configured to perform speech recognition on the electrical signals from the microphone that are associated with the captured speech audio.
